(19) United States
(12) Patent Application Publication
(10) Pub. No.: US 2009/0024498 A1
(43) Pub. Date: Jan. 22, 2009

(54) Establishing A Financial Market Data Component In A Financial Market Data System

(76) Inventors: John F. Berezuk, Georgetown, TX (US); Ronald B. Capelli, Round Rock, TX (US); John J. Duigenan, Long Island City, NY (US); Paul E. Foreman, Austin, TX (US); Hilary A. Pike, College Station, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/780,826

(22) Filed: Jul. 20, 2007

(51) Int. Cl. G06Q 40/00

(52) U.S. Cl. 705/35

(57) ABSTRACT

Methods, apparatus, and products are disclosed for establishing a financial market data component in a financial market data system that include: retrieving, by a configuration module from a configuration repository, at least a portion of a global system configuration for a financial market data system, the financial market data system comprising a plurality of financial market data components; identifying, by the configuration module in dependence upon the retrieved portion of the global system configuration, component characteristics of a particular financial market data component in the financial market data system, the component characteristics further comprise a system identifier, a component functional group identifier, and a component business group identifier; and deploying, by the configuration module, the financial market data component in the financial market data system in dependence upon the component characteristics.

### BACKGROUND OF THE INVENTION

1. Field of the Invention

The field of the invention is data processing, or, more specifically, methods, apparatus, and products for establishing a financial market data component in a financial market data system.

2. Description of Related Art

A financial market data system is a data processing environment used to communicate information about financial markets and participants in financial markets. A financial market data system is generally composed of various software components, or financial market data components, installed on various hardware platforms to process financial market data such as, for example, financial quotes, financial sales, or financial news. Financial quotes include bid and ask prices for any given financial security. A ‘bid’ refers to the highest price a buyer is willing to pay for a security. An ‘ask’ refers to the lowest price a seller is willing to accept for a security. Examples of various financial market data components may include software components that provide message stream administration services, feed adapter services, security services, high availability services, and so on.

In order for the financial market data system to operate, the various financial market data components must be integrated into a cohesive system across a number of networked connected hardware platforms. Integrating the various financial market data components into a cohesive system across a number of hardware platforms, however, is often a difficult task given the complexities associated with individual financial market data components and the relationships between those components. The drawback to integrating the various financial market data components into a cohesive system in the current art is that system administrators must separately configure each financial market data component to interoperate with the other components in the system. Because the configuration for each financial market data component typically has unique scope, terminology, formats, and syntax, configuring each component separately often does not express or exploit the underlying business process and application problem domain concepts that the integrated financial market data system must support. Furthermore, system administrators must exercise great care in consistently configuring each financial market data component to ensure that the various components can successfully connect, communicate, and interact to support solutions to the business processes and problem domain functions addressed by a particular financial market data system. Achieving consistent configuration among the components by manually creating the individual configuration files is often fraught with difficulty and error—especially as the complexity of the integrated system grows and the financial market data components are deployed across multiple hardware platforms. As such, readers will appreciate that room for improvement exists in establishing a financial market data component in a financial market data system.

### SUMMARY OF THE INVENTION

Methods, apparatus, and products are disclosed for establishing a financial market data component in a financial market data system that include: retrieving, by a configuration module from a configuration repository, at least a portion of a global system configuration for a financial market data system, the financial market data system comprising a plurality of financial market data components; identifying, by the configuration module in dependence upon the retrieved portion of the global system configuration, component characteristics of a particular financial market data component in the financial market data system, the component characteristics specifying a component configuration for the particular component and any interface configurations for any interfaces of the particular component with any other financial market data components in the financial market data system, the component characteristics further comprise a system identifier, a component functional group identifier, and a component business group identifier, the system identifier specifying a particular financial market data system within a business organization in which the particular component is comprised, the component functional group identifier specifying a type of function provided by the particular component within the financial market data system, the component business group identifier specifying a business role provided by the particular component within a set of the financial market data components having the same component functional group identifier; and deploying, by the configuration module, the financial market data component in the financial market data system in dependence upon the component characteristics.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and a block diagram illustrating an exemplary system for establishing a financial market data component in a financial market data system according to exemplary embodiments of the present invention.

FIG. 2 sets forth a block diagram of automated computing machinery comprising an exemplary configuration device useful in establishing a financial market data component in a financial market data system according to exemplary embodiments of the present invention.

FIG. 3 sets forth a flowchart illustrating an exemplary method for establishing a financial market data component in a financial market data system according to exemplary embodiments of the present invention.

FIG. 4 sets forth a line drawing illustrating an exemplary global system configuration useful in establishing a financial market data component in a financial market data system according to embodiments of the present invention.

FIG. 5 sets forth a line drawing illustrating exemplary interfaces of an exemplary financial market data component established in a financial market data system according to embodiments of the present invention.

FIG. 6 sets forth a flowchart illustrating an exemplary method for establishing a financial market data component in a financial market data system according to embodiments of the present invention.

### DETAILED DESCRIPTION OF EXEMPLARY EMBODIMENTS

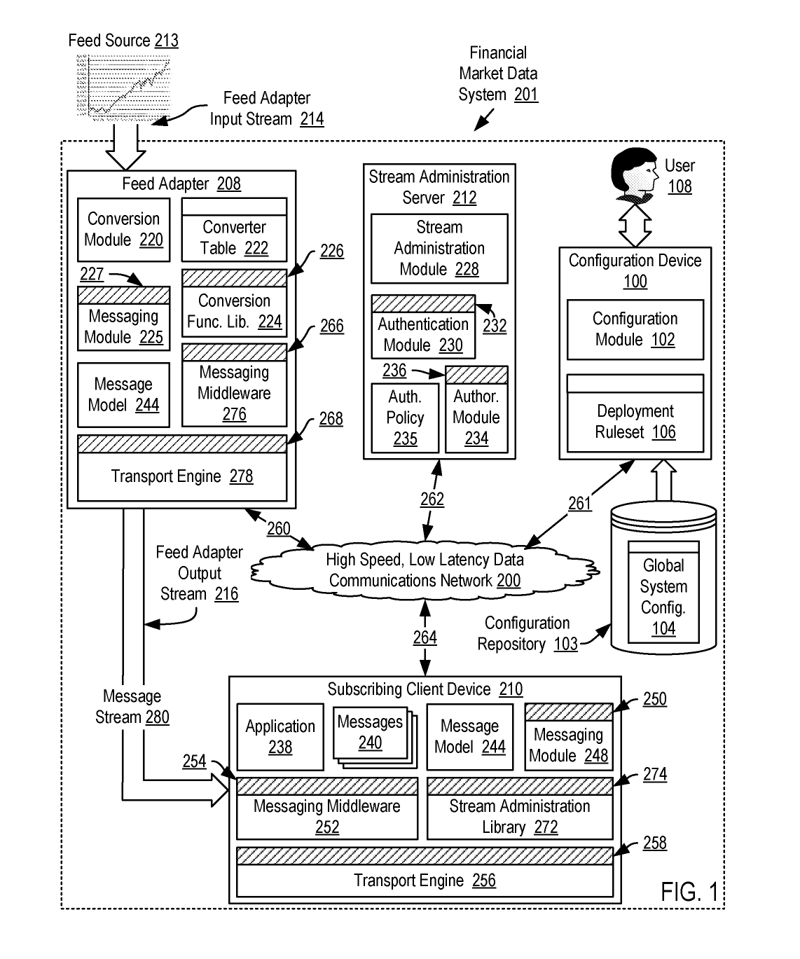

Exemplary methods, apparatus, and products for establishing a financial market data component in a financial market data system according to embodiments of the present invention are described with reference to the accompanying drawings, beginning with FIG. 1. FIG. 1 sets forth a network and a block diagram illustrating an exemplary system for establishing a financial market data component in a financial market data system according to embodiments of the present invention. The system of FIG. 1 operates generally to establishing a financial market data component in a financial market data system according to embodiments of the present invention as follows: A configuration module (102) retrieves, from a configuration repository (103), at least a portion (302) of a global system configuration (104) for a financial market data system (201). The financial market data system (201) includes a plurality of financial market data components. The configuration module (102) identifies component characteristics of a particular financial market data component in the financial market data system (201) in dependence upon the retrieved portion of the global system configuration (104). The component characteristics specify a component configuration for the particular component and any interface configurations for any interfaces of the particular component with any other financial market data components in the financial market data system (201). The configuration module (102) then deploys the financial market data component in the financial market data system (201) in dependence upon the component characteristics.

The financial market data system (201) illustrated in FIG. 1 includes a high speed, low latency data communications network (200). The network (200) includes a configuration device (100), a feed adapter (208), a stream administration server (212), and a subscribing client device (210), as well as the infrastructure for connecting such devices (208, 212, 210) together for data communications. The network (200) of FIG. 1 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (100, 208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in establishing a financial market data component in a financial market data system according to embodiments of the present invention may include a router.

The exemplary system of FIG. 1 includes a configuration device (100) connected to the high speed, low latency data communications network (200) through a wireline connection (261). The configuration device (100) of FIG. 1 is a computer device having installed upon it a configuration module (102). The configuration device (100) in the example of FIG. 1 also has installed upon it a deployment ruleset (106). Although the configuration device (100) of FIG. 1 is depicted as a device distinct from the other devices (208, 210, 212), readers will note that such a distinction is for explanation and not for limitation. In fact, any of the other devices (208, 210, 212) of FIG. 1 may also operate as a configuration device (100) provided the other device has installed upon it a configuration module (102) that operates for establishing a financial market data component in a financial market data system according to embodiments of the present invention.

In the exemplary system of FIG. 1, the configuration module (102) is a software component that includes a set of computer program instructions for establishing a financial market data component in a financial market data system according to embodiments of the present invention. The configuration module (102) operates generally for establishing a financial market data component in a financial market data system according to embodiments of the present invention by: retrieving at least a portion of a global system configuration (104) for the financial market data system (201) from a configuration repository (103); identifying component characteristics of a particular financial market data component (301) in the financial market data system (201) in dependence upon the retrieved portion (302) of the global system configuration (104); and deploying the financial market data component in the financial market data system (201) in dependence upon the component characteristics.

In the exemplary system of FIG. 1, the configuration repository (103) stores the global system configuration (104). The global system configuration (104) of FIG. 1 is a data structure that specifies the configuration of a financial market data system and its constituent financial market data components. The global system configuration (104) of FIG. 1 specifies the configuration of a financial market data system using the component characteristics for the individual components included in the financial market data system (201) and for the component's interfaces with the other components in the financial market data system (201). In such a manner, the global system configuration (104) operates to model the flow of data among the financial market data components of the financial market data system (201). Using the global system configuration (104), the configuration module (102) may derive individual configuration files for each of the financial market data components included in the financial market data system (201) of FIG. 1. A global system configuration may be implemented using a structured document, such as, for example, an XML document, a Java object, C++ object, entries in a database, entries in a Lightweight Directory Access Protocol (‘LDAP’) directory, or any other implementation as will occur to those of skill in the art. The configuration repository (103) of FIG. 1 in which the global system configuration (104) is stored may be implemented as a portion of a file system, an LDAP directory, a database, or any other implementation as will occur to those of skill in the art.

As mentioned above, the configuration module (102) identifies component characteristics for a particular financial market data component in the financial market data system (201) based on at least portion of the global system configuration (104). The component characteristics for a particular component specify a component configuration for the component and any interface configurations for any interfaces of the component with any other financial market data components in the financial market data system (201). The component characteristics include a system identifier that specifies a particular financial market data system within a business organization in which the particular component (301) is comprised. The system identifier is used in distinguishing to which financial market data system a particular component belongs in business organizations that have multiple financial market data system installations. For example, a business organization may have a financial market data system installed in New York, Austin, and Los Angeles, each financial market data system identified respectively by the following system identifiers: ‘NYC,’ ‘AUS,’ ‘LAC.’

The component characteristics also include a component functional group identifier that specifies a type of function provided by the particular component within the financial market data system (201). The type of function provided by the particular component represents a general non-business-specific function for which the particular component operates within the financial market data system (201). For example, types of functions provided by financial market data components may includes, feed adapter services, delay services, multicast receivers, event brokers, stream administration services, security services, directory services, database services, and so on.

The component characteristics also include a component business group identifier that specifies a business role provided by the particular component within a set of the financial market data components having the same component functional group identifier. The business role provided by the particular component is distinguished from the function type of the particular component in that the business role is a business-specific function performed by the component within a component functional group. The business role provided by the particular component may include the role that the component has to a particular business product, business user group, and so on. For example, the business roles provided by financial market data components within a ‘feed adapter service’ component functional group may include for example, providing a Bloomberg™ market data feed, a SIAC™ market data feed, a market data feed to a trading floor, a market data feed to a middle office, and so on.

The component characteristics also include a component business subgroup identifier that specifies an additional business role provided by a particular financial market data component within a set of financial market data components having the same component functional group identifier and the same component business group identifier. Specifying an additional business role for the particular financial market data component adds an additional layer of granularity for which components may be controlled and configured. For example, the additional business roles provided by financial market data components within the ‘feed adapter service’ component functional group and the ‘SIAC™ market data feed’ component business group may include providing market data from the Consolidated Tape System (‘CTS’) or providing market data from the Consolidated Quote System (‘CQS’).

In the exemplary system of FIG. 1, each financial market data component may have one or more instances. The component characteristics for each instance of a component include a component instance identifier to distinguish instances of a particular financial market data component. Each instance of a particular financial market data component belongs to a high availability tier and provides equivalent functionality within the financial market data system. Having more than one instance of a financial market data component helps to ensure that the financial market data system can process financial market data in the event of a hardware or software failure.

In the exemplary system of FIG. 1, the configuration module (102) may deploy the financial market data component in the financial market data system (201) in dependence upon the component characteristics by determining a component deployment configuration in dependence upon the component characteristics and a deployment ruleset (106) and configuring one or more computing devices with the financial market data component in dependence upon the component deployment configuration. The deployment ruleset (106) of FIG. 1 specifies a set of rules for deriving a component deployment configuration for a particular financial market data component based on component characteristics for the financial market data component. The component deployment configuration for a financial market data component includes all the information required to instantiate the financial market data component in the financial market data environment according to the global system configuration (104). In the example of FIG. 1, the deployment ruleset (106) may be implemented using a structured document, such as, for example, an XML document, a Java object, C++ object, or any other implementation as will occur to those of skill in the art.

In the exemplary system of FIG. 1, the configuration module (102) may also operate for establishing a financial market data component in a financial market data system according to embodiments of the present invention by: generating a graphical representation of the financial market data system in dependence upon a portion of the global system configuration (104) and displaying the graphical representation of the financial market data system on a graphical user interface to a user (108). Only a portion of the global system configuration (104) may be required to generate a graphical representation of the financial market data system because, as discussed in detail below, only a component's system identifier, component function group identifier, component business group identifier, component business subgroup identifier, and instance identifiers are typically used in generating the graphical representation of the entire financial market data system.

As mentioned above, a financial market data system is generally composed of various financial market data components installed on various network connected hardware platforms. For example, a financial market data system may be composed of a feed adapter service, a stream administration service, a high availability service, a messaging middleware service, a client application, or any other financial market data component installed on various computing devices. A more detailed description of the various financial market data components in an exemplary financial market data system is now set forth below. Readers will note, however, that the exemplary financial market data system described below is for explanation and not for limitation. Other financial market data systems may include additional financial market data components not described below and be configured in a manner other than the manner described below.

The financial market data system (201) depicted in FIG. 1 includes a message stream (280). A message stream is a data communication channel between a communications endpoint of a sending device and a communications endpoint of at least one receiving device for transmitting application messages. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

An application message is a quantity of data organized into one or more data fields recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions. In a financial market data system, an application message is commonly referred to as a ‘tick’ and includes financial market data such as, for example, financial quotes, financial sales, or financial news. Financial quotes include bid and ask prices for any given financial security. A ‘bid’ refers to the highest price a buyer is willing to pay for a security. An ‘ask’ refers to the lowest price a seller is willing to accept for a security.

The exemplary system of FIG. 1 includes a stream administration server (212) connected to the high speed, low latency data communications network (200) through a wireline connection (262). The stream administration server (212) of FIG. 1 is a computer device that provides stream administration services. The stream administration server (212) of FIG. 1 has installed upon it a stream administration module (228), an authentication module (230), an authorization module (234), and an authorization policy (235). A stream administration module (228) is a software component that includes a set of computer program instructions configured for administering message streams between feed adapters and client devices. A stream administration module (228) may administer the message streams by brokering establishment of a message stream (280) from the message sending device to a message receiving device. The message stream (280) provides the application messages to the subscribing client device (210) from the feed adapter (208).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the subscribing client device (210) is authorized to receive on the message stream (280). The authorization module (234) of FIG. 1 provides authorization security services using an authorization policy (235). The authorization policy (235) is a set of rules governing the privileges of authenticated entities to send or receive application messages on a message stream. In a financial market data system, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 1, feed adapter (208) is connected to the high speed, low latency data communications network (200) through a wireline connection (260). The feed adapter (208) of FIG. 1 is a computer device that provides feed adapter services within a financial market data system. The feed adapter (208) of FIG. 1 has the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 1, the feed adapter (208) receives application messages on the feed adapter input stream (214) from a feed source (213). The feed source (213) is a computer device capable of aggregating data into application messages and transmitting the messages to a feed adapter. In a financial market data system, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data system may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Centers^{SM} which is an electronic screen-based equity securities market in the United States. In a financial market data system, a feed adapter input stream is referred to as a ‘financial market data feed.’

The feed adapter (208) of FIG. 1 has installed upon it a conversion module (220), a converter table (222), conversion function library (224), a messaging module (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 1 is a data structure that specifies the converter functions capable of converting the application message from one format to another format. Utilizing multiple converter tables, the conversion module (220) may convert messages from a variety of input formats to a variety of output formats. In the example of FIG. 1, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 1 may be implemented using a structured document such as, for example, an eXtensible Markup Language (‘XML’) document.

The conversion function library (224) of FIG. 1 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 1, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 1, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). In the example of FIG. 1, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 1, the conversion module (220) and the converter functions of the conversion function library (224) process the data contained in the application messages (240) using the messaging module (225). The messaging module (225) is a software module that includes a set of functions for creating, accessing, and manipulating messages (240) according to a message model (244). The messaging module (225) is accessible to the conversion module (220), the converter functions of the conversion function library (224), and the messaging middleware (276) through a message API (227) exposed by the messaging module (225).

Before the conversion module (220) of FIG. 1 performs data processing on the application messages, the conversion module (220) receives application messages (not shown) having a first format from the feed source (213). The conversion module (220) of FIG. 1 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 1 performs data processing on the application messages received from the feed source (213), the conversion module (220) provides the application messages having the second format to the messaging middleware (276). The messaging middleware (276) of FIG. 1 is a software component that provides high availability services between the feed adapter (208), any backup feed adapter that may exist, the subscribing client device (210), and the feed source (213). In addition, the messaging middleware (276) of FIG. 1 also provides administrative services regarding the application messages such as, for example, receiving application messages from the conversion module (220), inserting sequence numbers into the application messages, and providing the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for receiving application messages from the messaging middleware (276) and transmitting the application messages to the subscribing client device (210) on the message stream (280). The transport engine (278) transmits the application messages (240) to the subscribing client device (210) by encapsulating the application messages provided by the messaging middleware (276) into transport packets and transmitting the packets through the message stream (280) to the subscribing client device (210). The messaging middleware (276) operates the transport engine (278) through a transport API (268) exposed by the transport engine (278).

The subscribing client device (210) in exemplary system of FIG. 1 connects to the high speed, low latency data communications network (200) through a wireline connection (264). The subscribing client device (210) of FIG. 1 is a computer device that supports a client application capable of subscribing to the message streams transmitted by various feed adapters. In a financial market data system, for example, a subscribing client device may subscribe to a tick to receive the bid and ask prices for a particular security on a message stream provided by a feed adapter controlled by a financial securities broker.

In the example of FIG. 1, the subscribing client device (210) has installed upon it an application (238), a messaging module (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data system, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the messaging module (248). The messaging module (248) is software module that includes a set of functions for creating, accessing, and manipulating messages (240) according to the message model (244) that is installed on both the feed adapter (208) and the subscribing client device (210). The messaging module (248) is accessible to the application (238) through a message API (250) exposed by the messaging module (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 1 may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™.

The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) of FIG. 1 also provides administrative services regarding the application messages such as, for example, filtering application message received from the feed adapter (208) according to constraints provided by the stream administration server (212). The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. In the example of FIG. 1, the transport engine (256) includes a set of computer program instructions for receiving transport packets from the feed adapter (208), unencapsulating the application messages (240) from the transport packets, and providing the message (240) to the messaging middleware (252). The messaging middleware (252) of FIG. 1 operates the transport engine (256) through a transport API (258) exposed by the transport engine (256).

Readers will note that the servers and other devices illustrated in the exemplary system of FIG. 1 are for explanation, not for limitation. Devices useful in establishing a financial market data component in a financial market data system may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 is also for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

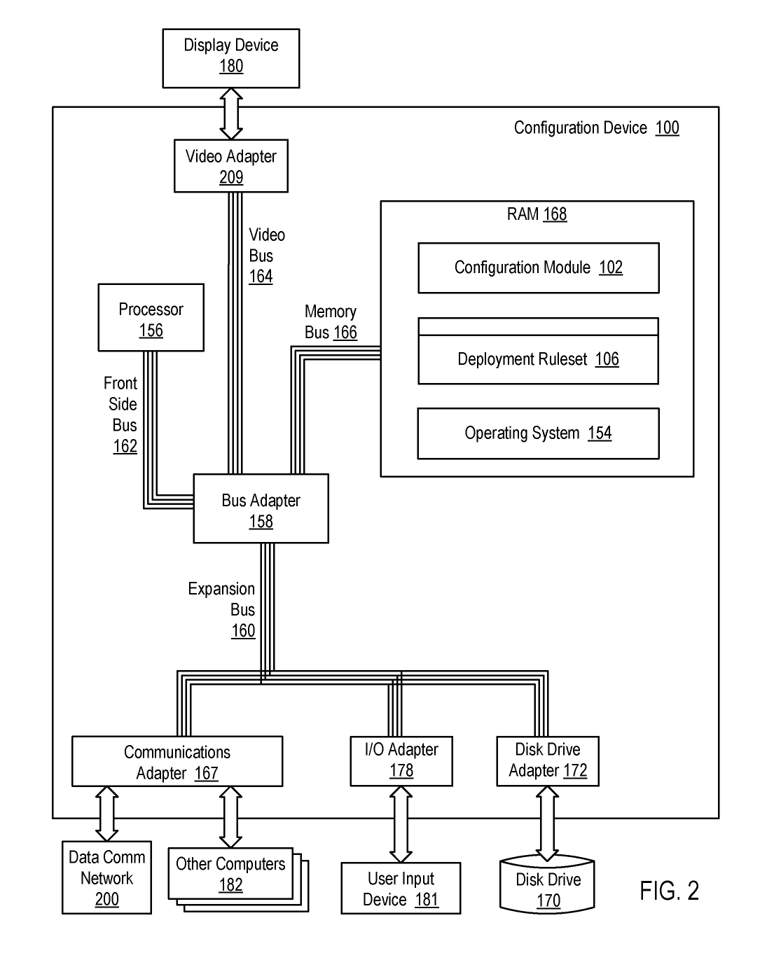

Establishing a financial market data component in a financial market data system in accordance with the present invention in some embodiments may be implemented with a configuration device. Such a device is, in turn, implemented to some extent at least as computers, that is, automated computing machinery. For further explanation, therefore, FIG. 2 sets forth a block diagram of automated computing machinery comprising an exemplary configuration device (100) useful in establishing a financial market data component in a financial market data system according to embodiments of the present invention. The configuration device (100) of FIG. 2 includes at least one computer processor (156) or ‘CPU’ as well as random access memory (168) (‘RAM’) which is connected through a high speed memory bus (166) and bus adapter (158) to processor (156) and to other components of the configuration device.

Stored in RAM (168) are a configuration module (102) and a deployment ruleset (106). The configuration module (102) illustrated in FIG. 2 is a software component, that is computer program instructions, that operates as described above with reference to FIG. 1. The deployment ruleset (106) of FIG. 2 specifies a sets of rules for deriving a component deployment configuration for a particular financial market data component based on component characteristics for the financial market data component. The component deployment configuration for a financial market data component includes all the information required to instantiate the financial market data component in the financial market data environment according to a global system configuration accessible through a configuration repository. The deployment ruleset (106) may be implemented using a structured document, such as, for example, an XML document, a Java object, C++ object, or any other implementation as will occur to those of skill in the art.

Also stored in RAM (168) is an operating system (154). Operating systems useful in configuration devices according to embodiments of the present invention include UNIX™, Linux™, Microsoft NT™, IBM's AIX™, IBM's i5/OS™, and others as will occur to those of skill in the art. The operating system (154), the configuration module (102) and the deployment ruleset (106) in the example of FIG. 2 are shown in RAM (168), but many components of such software typically are stored in non-volatile memory also, for example, on a disk drive (170).

The exemplary configuration device (100) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in configuration devices useful according to embodiments of the present invention include the Intel Northbridge, the Intel Memory Controller Hub, the Intel Southbridge, and the Intel I/O Controller Hub. Examples of expansion buses useful in configuration devices useful according to embodiments of the present invention may include Peripheral Component Interconnect (‘PCI’) buses and PCI Express (‘PCIe’) buses.

The exemplary configuration device (100) of FIG. 2 also includes disk drive adapter (172) coupled through expansion bus (160) and bus adapter (158) to processor (156) and other components of the exemplary configuration device (100). Disk drive adapter (172) connects non-volatile data storage to the exemplary configuration device (100) in the form of disk drive (170). Disk drive adapters useful in configuration devices include Integrated Drive Electronics (‘IDE’) adapters, Small Computer System Interface (‘SCSI’) adapters, and others as will occur to those of skill in the art. In addition, non-volatile computer memory may be implemented for a configuration device as an optical disk drive, electrically erasable programmable read-only memory (so-called ‘EEPROM’ or ‘Flash’ memory), RAM drives, and so on, as will occur to those of skill in the art.

The exemplary configuration device (100) of FIG. 2 includes one or more input/output (‘I/O’) adapters (178). I/O adapters in configuration devices implement user-oriented input/output through, for example, software drivers and computer hardware for controlling output to display devices such as computer display screens, as well as user input from user input devices (181) such as keyboards and mice. The exemplary configuration device (100) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary configuration device (100) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for establishing a financial market data component in a financial market data system according to embodiments of the present invention include modems for wired dial-up communications, IEEE 802.3 Ethernet adapters for wired data communications network communications, and IEEE 802.11b adapters for wireless data communications network communications.

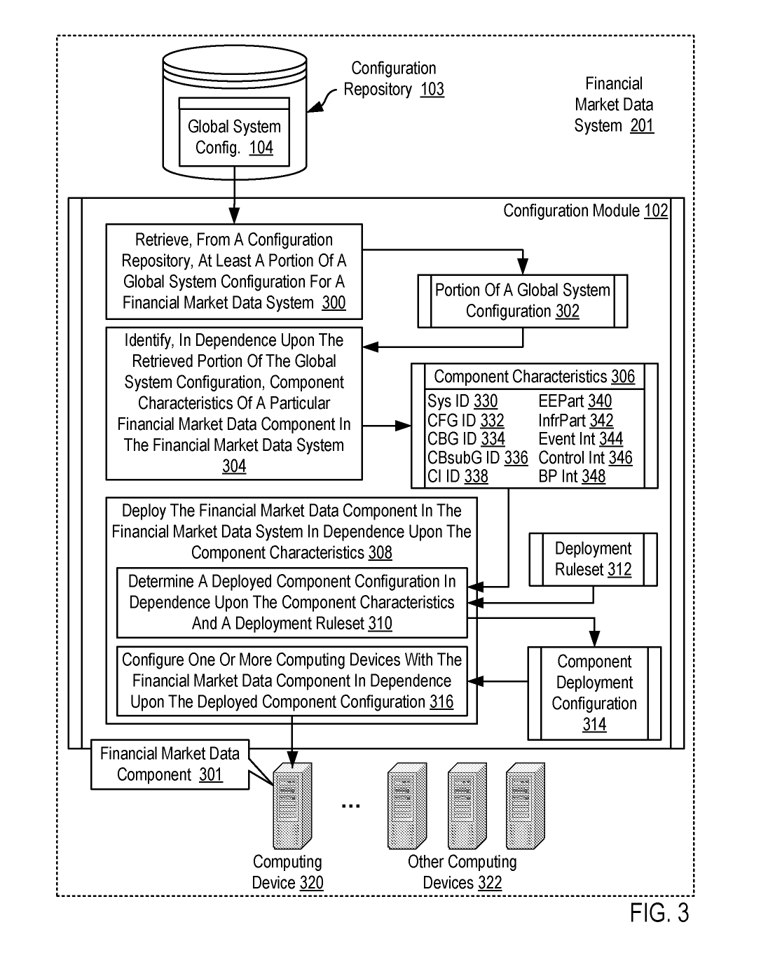

For further explanation, FIG. 3 sets forth a flowchart illustrating an exemplary method for establishing a financial market data component in a financial market data system according to embodiments of the present invention. The financial market data system (201) of FIG. 3 includes a plurality of financial market data components. The method of FIG. 3 includes retrieving (300), by a configuration module (102) from a configuration repository (103), at least a portion (302) of a global system configuration (104) for a financial market data system (201). The global system configuration (104) of FIG. 3 is a data structure that specifies the configuration of a financial market data system and its constituent financial market data components. The global system configuration (104) of FIG. 3 specifies the configuration of a financial market data system using the component characteristics for the individual components included in the financial market data system (201) and for the component's interfaces with the other components in the financial market data system (201). In such a manner, the global system configuration (104) operates to model the flow of data among the financial market data components of the financial market data system (201). Using the global system configuration (104), the configuration module (102) may derive individual configuration files for each of the financial market data components included in the financial market data system (201) of FIG. 3. A global system configuration may be implemented using a structured document, such as, for example, an XML document, a Java object, C++ object, entries in a database, entries in a Lightweight Directory Access Protocol (‘LDAP’) directory, or any other implementation as will occur to those of skill in the art. The configuration repository (103) of FIG. 3 in which the global system configuration (104) is stored may be implemented as a portion of a file system, an LDAP directory, a database, or any other implementation as will occur to those of skill in the art.

The manner in which the configuration module (102) retrieves (300) the portion (302) of the global system configuration (104) for the financial market data system (201) from the configuration repository (103) according to the method of FIG. 3 may vary depending on the implementation of the global system configuration (104). When the global system configuration (104) is implemented as an XML document, the configuration module (102) may retrieve (300) the portion (302) of the global system configuration (104) for the financial market data system (201) according to the method of FIG. 3 by traversing the directory structure of a file system for the global system configuration (104) and loading at least a portion of the global system configuration (104) into computer memory accessible by the configuration module (102). When the global system configuration (104) is implemented as entries in a database, the configuration module (102) may retrieve (300) the portion (302) of the global system configuration (104) for the financial market data system (201) according to the method of FIG. 3 by querying the database for portion of the global system configuration (104) relevant to a particular financial market data component (301).

The method of FIG. 3 also includes identifying (304), by the configuration module (102) in dependence upon the retrieved portion (302) of the global system configuration (104), component characteristics (306) of a particular financial market data component (301) in the financial market data system (201). The manner in which the configuration module (102) identifies (304) component characteristics (306) of a particular financial market data component (301) in the financial market data system (201) according to the method of FIG. 3 may vary by implementation of the global system configuration (104). For example, when the global system configuration (104) is implemented as an XML document, the configuration module (102) may identify (304) component characteristics (306) according to the method of FIG. 3 by parsing the retrieved portion (302) of the global system configuration (104) for XML tags specifying the beginning and the end of the component characteristics for the particular component (301). For further example, when the global system configuration (104) is implemented as entries in a database, the configuration module (102) may identify (304) component characteristics (306) according to the method of FIG. 3 as the results returned from querying the database for the component characteristics for the particular component (301).

The component characteristics (306) of FIG. 3 for the particular component (301) specify a component configuration for the component (301) and any interface configurations for any interfaces of the component (301) with any other financial market data components in the financial market data system (201). The component characteristics (306) include a system identifier (330) that specifies a particular financial market data system within a business organization in which the particular component (301) is comprised. The system identifier is used in distinguishing to which financial market data system a particular component belongs in business organizations that have multiple financial market data system installations. For example, a business organization may have a financial market data system installed in New York, Austin, and Los Angeles, each financial market data system identified respectively by the following system identifiers: ‘NYC,’ ‘AUS,’ ‘LAC.’

The component characteristics (306) of FIG. 3 also include a component functional group identifier (332) that specifies a type of function provided by the particular component within the financial market data system (201). The type of function provided by the particular component represents a general non-business-specific function for which the particular component operates within the financial market data system (201). For example, types of functions provided by financial market data components may includes, feed adapter services, delay services, multicast receivers, event brokers, stream administration services, security services, directory services, database services, and so on.

The component characteristics (306) of FIG. 3 also include a component business group identifier (334) that specifies a business role provided by the particular component within a set of the financial market data components having the same component functional group identifier. The business role provided by the particular component is distinguished from the function type of the particular component in that the business role is a business-specific function performed by the component within a component functional group. The business role provided by the particular component may include the role that the component has to a particular business product, business user group, and so on. For example, the business roles provided by financial market data components within a ‘feed adapter service’ component functional group may include for example, providing a Bloomberg™ market data feed, a SIAC™ market data feed, a market data feed to a trading floor, a market data feed to a middle office, and so on.

The component characteristics (306) of FIG. 3 also include a component business subgroup identifier (336) that specifies an additional business role provided by a particular financial market data component within a set of financial market data components having the same component functional group identifier and the same component business group identifier. Specifying an additional business role for the particular financial market data component adds an additional layer of granularity for which components may be controlled and configured. For example, the additional business roles provided by financial market data components within the ‘feed adapter service’ component functional group and the ‘SIAC™ market data feed’ component business group may include providing market data from the Consolidated Tape System (‘CTS’) or providing market data from the Consolidated Quote System (‘CQS’).

In the example of FIG. 3, the financial market data component (301) is implemented in the financial market data system (201) with more than one instance. The component characteristics (306) for each instance of the component (301) include a component instance identifier (330) to distinguish instances of the particular financial market data component (301). Each instance of the component (301) belongs to a high availability tier and provides equivalent functionality within the financial market data system. Having more than one instance of a financial market data component helps to ensure that the financial market data system can process financial market data in the event of a hardware or software failure.

In addition to specifying system, group, and subgroup identifiers for the particular financial market data component (301), the component characteristics (306) of FIG. 3 also specify various interfaces through which the component (301) communications with other financial market data components in the financial market data system (201) and external components outside of the financial market data system (201). In the example of FIG. 3, the component characteristics (306) specify an external edge partition (340) through which the financial market data component exchanges data with external components outside of the financial market data system (201). For example, a feed adapter service exchanges data with a market data feed provider through an external edge partition that is unidirectional or bidirectional. Through the external edge partition, the feed adapter service receives ticks from a market data feed provider such as, for example, OPRA or SIAC™. To provide bidirectional exchanges, some market data feed providers supply a set of API calls to the feed adapter service for administering the market data feed. For example, Bloomberg™ provides a set of API calls used by a feed adapter service to request the start and stop of portions of the Bloomberg™ market data feed. The component characteristics for a feed adapter service financial market data component may specify such an external edge partition by specifying information regarding the data model of the ticks received from the market data feed provider, connection information for data communication channel through which the ticks are received, any other interface information as will occur to those of skill in the art.

In the example of FIG. 3, the component characteristics (306) also specify an infrastructure partition (342) through which the financial market data component exchanges application messages with other financial market data components inside the financial market data system (201). For example, a feed adapter service's infrastructure partition may provide data exchanges with a client application installed on a subscribing client device. The component characteristics (306) may specify an infrastructure partition by specifying connection information for data communication channels used to communicate with other financial market data components.

The component characteristics (306) of FIG. 3 also specify an event interface (344) through which the financial market data component exchanges state information with other financial market data components within the financial market data system. The event interface may provide a set of event delivery services through a standard set of operational state manager functions and high availability functions. Through an event interface, the financial market data component (301) may advise its state or the detected state of another component to an operational state manager, which serves a repository of state information for various components in the financial market data system (201). Through the event interface, the financial market data component (301) may also be advised of the state of a financial market data component in which the financial market data component (301) has an interest or a dependency.

The component characteristics (306) of FIG. 3 also specify a control interface (346) through which the financial market data component exchanges control messages with other financial market data components within the financial market data system. The control interface may provide a set of control message delivery services through a standard set of operational state manager functions. Through the control interface, the financial market data component (301) may send a control message to another financial market data component that triggers a change in the processing state of the other financial market data component. Similarly, through the control interface, the financial market data component (301) may receive a control message from another financial market data component that triggers a change in the processing state of the financial market data component (301).

The component characteristics (306) of FIG. 3 also specify a business process interface (348) through which the financial market data component exchanges business process messages with other financial market data components within the financial market data system. For example, through a business process interface between a feed adapter service and a stream administration service, the feed adapter service may receive a business process request from the stream administration service to send a message to the provider of a financial market data feed through the feed adapter service's external edge partition. In such a case, the component characteristics may specify the business process interface by specifying a port to which the stream administration service sends messages or by specifying a topic of an event broker used to subscribe to business process messages from a stream administration service.

The method of FIG. 3 includes deploying (308), by the configuration module (102), the financial market data component (301) in the financial market data system (201) in dependence upon the component characteristics (306). The configuration module (102) deploys (308) the financial market data component (301) in the financial market data system (201) in the method of FIG. 3 by determining (310) a component deployment configuration (314) in dependence upon the component characteristics (306) and a deployment ruleset (312) and configuring (316) one or more computing devices (320, 322) with the financial market data component (301) in dependence upon the component deployment configuration (314).

The deployment ruleset (106) of FIG. 3 represents a set of deployment rules for deriving a component deployment configuration (314) for a particular financial market data component based on component characteristics (306) for the financial market data component. The component deployment configuration (314) of FIG. 3 represents all the information for instantiating the financial market data component (301) in the financial market data environment (201) according to the global system configuration (104). That is, the component deployment configuration (314) may be differentiated from the component characteristics (306) in that the component deployment configuration (314) for instantiating the component (301) is derived from the component characteristics (306) stored in the global system configuration (104). For example, the component deployment configuration (314) may specify parameters used to construct an instance of the financial market data component, variable values for initializing an instance of the financial market data component, and so on. In the example of FIG. 3, the deployment ruleset (106) may be implemented as a data structure such as an XML document used to lookup the component deployment configuration (314) based on the component characteristics (306). In other embodiments, the deployment ruleset (106) may be coded into the logic of a Java object or C++ object implementing the configuration module (102), or any other implementation as will occur to those of skill in the art.

The manner in which the configuration module (102) determines (310) a component deployment configuration (314) in dependence upon the component characteristics (306) and a deployment ruleset (312) according to the method of FIG. 3 may vary depending on the implementation of the deployment ruleset (312). For example, when the deployment ruleset (312) is implemented as an XML document, the configuration module (102) may determine (310) a component deployment configuration (314) in dependence upon the component characteristics (306) and a deployment ruleset (312) according to the method of FIG. 3 by parsing the XML document and identifying a portion of the XML document containing the component deployment configuration (314) corresponding to the component characteristics (306). When the deployment ruleset (312) is implemented in the logic of a Java object or C++ object implementing the configuration module (102), the configuration module (102) may determine (310) a component deployment configuration (314) in dependence upon the component characteristics (306) and a deployment ruleset (312) according to the method of FIG. 3 by branching, based on the component characteristics (306), to a set of computer program instructions within the configuration module (102) for instantiating the financial market data component.

The configuration module (102) may configure (316) one or more computing devices (320, 322) with the financial market data component (301) in dependence upon the component deployment configuration (314) according to the method of FIG. 3 by providing the component deployment configuration (314) to an execution environment operating on the computing device (320) and instructing the execution environment to instantiate the financial market data component (301) using the component deployment configuration (314). The execution environment on the computing device (320) may then construct, initialize, and administer the financial market data component (301) according to the component deployment configuration (314). When component characteristics (306) for the financial market data component (301) specify deploying more than one instance of the component (301), then the configuration module (102) may configure (316) each instance on a separate computing device (320, 322).

Readers will note that an ‘instance’ of the financial market data component is any runtime version of the financial market data component that is deployed in a financial market data system. The term ‘instance’ does not require that the financial market data component be a runtime version of a traditional object oriented class such as, for example, a C++ class or a Java class, although such implementations are not precluded. An instance of a financial market data component may also include a copy of a data structure such as, for example, an XML document, configured for use in the financial market data system during runtime. In a similar manner, readers will note that the terms ‘instantiate’ or ‘instantiating’ mean configuring a runtime version of the financial market data component for use in a financial market data system.

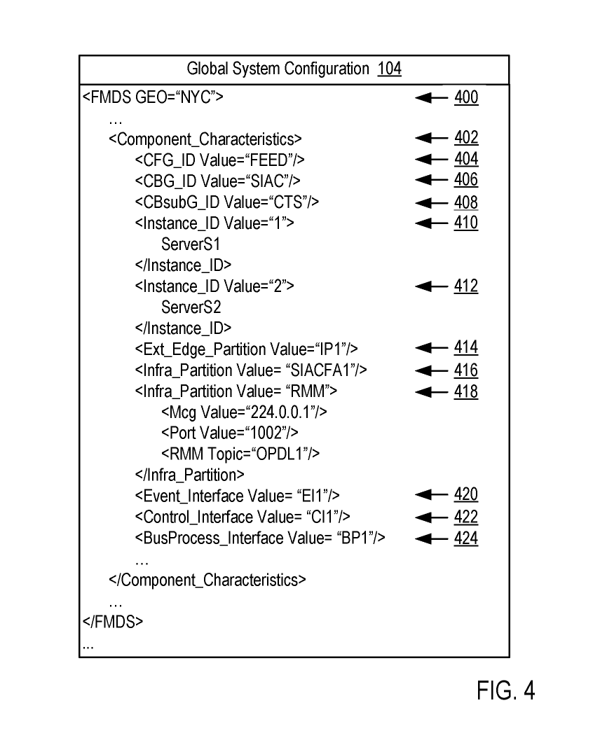

For further explanation of a global system configuration, FIG. 4 sets forth a line drawing illustrating an exemplary global system configuration useful in establishing a financial market data component in a financial market data system according to embodiments of the present invention. The portion of the exemplary global system configuration (104) illustrated in FIG. 4 depicts component characteristics (402) for a financial market data component implemented as a feed adapter service. In the example of FIG. 4, the component characteristics (402) specify a system identifier (400) that specifies a particular financial market data system within a business organization in which the particular financial market data component is comprised. The component characteristics (402) specify the system identifier (400) by being encapsulated in the XML tags ‘<FMDS GEO=“NYC”>’ and ‘</FMDS>,’ which specifies a system identifier having a value of ‘NYC.’ A value of ‘NYC’ indicates that the financial market data system is the deployed in the New York office of a particular business organization.

The component characteristics (402) of FIG. 4 includes a component functional group identifier (404) that specifies a type of function provided by the particular component within the financial market data system (201). In the example of FIG. 4, the component functional group identifier (404) has a value of ‘FEED,’ which indicates that the financial market data component specified by the component characteristics (402) is a feed adapter service.

The component characteristics (402) of FIG. 4 also include a component business group identifier (406) that specifies a business role provided by the particular component within a set of the financial market data components having the same component functional group identifier. As mentioned above, the business role provided by the particular component is distinguished from the function type of the particular component in that the business role is a business-specific function performed by the component within a component functional group. In the example of FIG. 4, the component business group identifier (406) has a value of ‘SIAC,’ which indicates that the feed adapter service specified by the component characteristics (402) provides a SIAC™ market data.

The component characteristics (402) of FIG. 4 also include a component business subgroup identifier (408) that specifies an additional business role provided by a particular financial market data component within a set of financial market data components having the same component functional group identifier and the same component business group identifier. Specifying an additional business role for the particular financial market data component adds an additional layer of granularity for which components may be controlled and configured. In the example of FIG. 4, the component business subgroup identifier (408) has a value of ‘CTS,’ which indicates that the SIAC™ market data provided by the feed adapter service specified by the component characteristics (402) provides market data from the Consolidated Tape System (‘CTS’).

In the example of FIG. 4, the financial market data component specified by the component characteristics (402) is implemented in the financial market data system (201) with two instances. The component characteristics (402) of FIG. 4 specify the first instance using an instance identifier (410) and specify the second instance using an instance identifier (412). In the example of FIG. 4, the instance identifier (410) has a value of ‘1,’ and the component characteristics (402) for the first instance indicates that the first instance of the financial market data component is deployed on a computing device identified as ‘ServerS1.’ In the example of FIG. 4, the instance identifier (412) has a value of ‘2,’ and the component characteristics (402) for the second instance indicates that the second instance of the financial market data component is deployed on a computing device identified as ‘ServerS2.’

As mentioned above, in addition to specifying system, group, and subgroup identifiers for the particular financial market data component, the component characteristics (402) of FIG. 4 also specify various interfaces through which the component communications with other financial market data components in the financial market data system and external components outside of the financial market data system. In the example of FIG. 4, the component characteristics (402) specify an external edge partition through which the financial market data component exchanges data with external components outside of the financial market data system. The component characteristics (402) specify the external edge partition for use by the feed adapter service using a value of ‘IP1’ in an ‘Ext_Edge_Partition’ XML tag (414).

In the example of FIG. 4, the component characteristics (402) also specify two infrastructure partitions through which the financial market data component exchanges application messages with other financial market data components inside the financial market data system. The component characteristics (402) specify the first infrastructure partition for use by the feed adapter service using a value of ‘SIACFA1’ in an ‘Infra_Partition’ XML tag (416). The component characteristics (402) specify the second infrastructure partition for use by the feed adapter service using a value of ‘RMM’ in an ‘Infra_Partition’ XML tag (418). Because a configuration module typically needs additional information for an RMM infrastructure partition, the component characteristics (402) also specify a multicast address of ‘224.0.0.1,’ a port value of ‘1002,’ and an RMM Topic value of ‘OPDL1.’

The component characteristics (402) of FIG. 4 also specify an event interface through which the financial market data component exchanges state information with other financial market data components within the financial market data system. In the example of FIG. 4, the component characteristics (402) specify the event interface created for the financial market data component using a value of ‘EI1’ in an ‘Event_Interface’ XML tag (420).

The component characteristics (402) of FIG. 4 also specify a control interface through which the financial market data component exchanges control messages with other financial market data components within the financial market data system. In the example of FIG. 4, the component characteristics (402) specify the control interface created for the financial market data component using a value of ‘CI1’ in an ‘Control_Interface’ XML tag (422).

The component characteristics (402) of FIG. 4 also specify a business process interface through which the financial market data component exchanges business process messages with other financial market data components within the financial market data system. In the example of FIG. 4, the component characteristics (402) specify the business process interface created for the financial market data component using a value of ‘BP1’ in an ‘BusProcess_Interface’ XML tag (422).

Readers will note that the global system configuration (104) illustrated in FIG. 4 is implemented as an XML document for ease of explanation and not limitation. Other implementations of a global system configuration as will occur to those of skill in the art may also be useful in establishing a financial market data component in a financial market data system according to embodiments of the present invention.

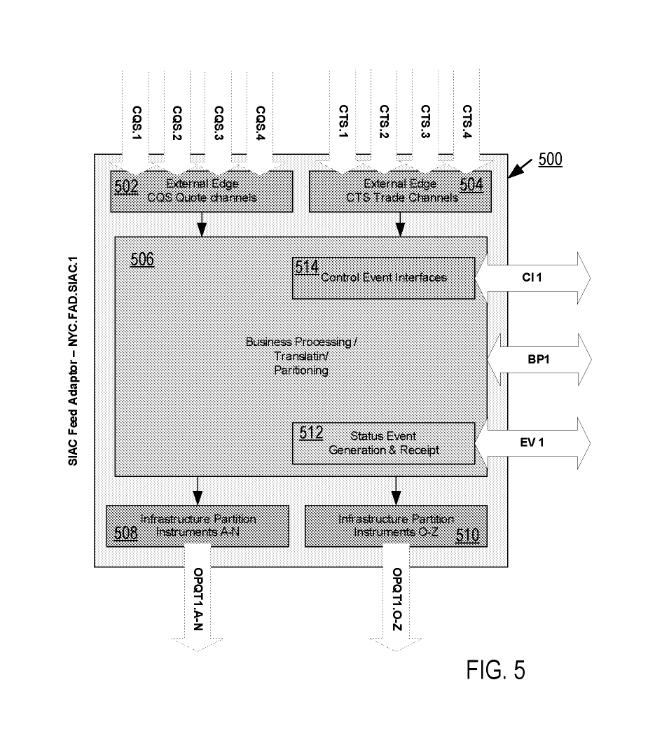

For further explanation of the interfaces of a financial market data component, FIG. 5 sets forth a line drawing illustrating exemplary interfaces of an exemplary financial market data component established in a financial market data system according to embodiments of the present invention. The exemplary financial market data component (500) illustrated in FIG. 5 is a feed adapter service that provides SIAC™ market data to other financial market data components in the financial market data system.

The feed adapter service (500) of FIG. 5 includes eight external edge partitions. Through the first set (502) of four external edge partitions, the component (500) receives SIAC™ quote ticks through four CQS quote channels. A quote tick is a financial market data tick that contains quote information for a financial instrument. Through the second set (504) of four external edge partitions, the component (500) receives SIAC™ trade ticks through four CTS trade channels. A trade tick is a financial market data tick that contains information regarding a sale of a financial instrument.

Because a feed adapter service (500) operating in a financial market data system typically distributes the received ticks to subscribing client devices through a high speed, low latency data communications network, the business processing logic (506) of the feed adapter service (500) of FIG. 5 only utilizes two infrastructure partitions (508, 510) for transmitting the financial ticks to other financial market data components in a financial market data system. The business processing logic (506) portion of the feed adapter service (500) determines which infrastructure partition is used to transmit each financial tick based on the first letter of the financial instrument or symbol for the tick. In the example of FIG. 5, the first infrastructure partition (508) is used to transmit financial ticks for financial instruments having a symbol that begins with any of the letters ‘A’ through ‘N.’ The second infrastructure partition (510) is used to transmit financial ticks for financial instruments having a symbol that begins with any of the letters ‘O’ through ‘Z.’

In the example of FIG. 5, the financial market data component also includes status event generation and receipt logic (512). The status event generation and receipt logic (512) that implements an event interface ‘EV1’ allows the feed adapter service (500) to exchange state information with other financial market data components within a financial market data system. The event interface may provide a set of event delivery services through a standard set of operational state manager functions and high availability functions. Through an event interface, the financial market data component (500) may advise its state or the detected state of another component to an operational state manager, which serves a repository of state information for various components in a financial market data system. Through the event interface, the financial market data component (500) may also be advised of the state of a financial market data component in which the financial market data component (500) has an interest or a dependency.

In the example of FIG. 5, the financial market data component also includes control interface logic (514). The control interface logic (514) implements a control interface ‘CI1’ through which the feed adapter service (500) exchanges control messages with other financial market data components within the financial market data system. The control interface may provide a set of control message delivery services through a standard set of operational state manager functions. Through the control interface, the financial market data component (500) may send a control message to another financial market data component that triggers a change in the processing state of the other financial market data component. Similarly, through the control interface, the financial market data component (500) may receive a control message from another financial market data component that triggers a change in the processing state of the financial market data component (500).

In the example of FIG. 5, the financial market data component also includes business processing logic (506). The business processing logic (506) implements a business process interface ‘BP1’ through which the financial market data component exchanges business process messages with other financial market data components within the financial market data system. For example, through a business process interface, the feed adapter service (500) may receive a business process request from a stream administration service to send a message to the provider of a financial market data feed through the feed adapter service's external edge partition.

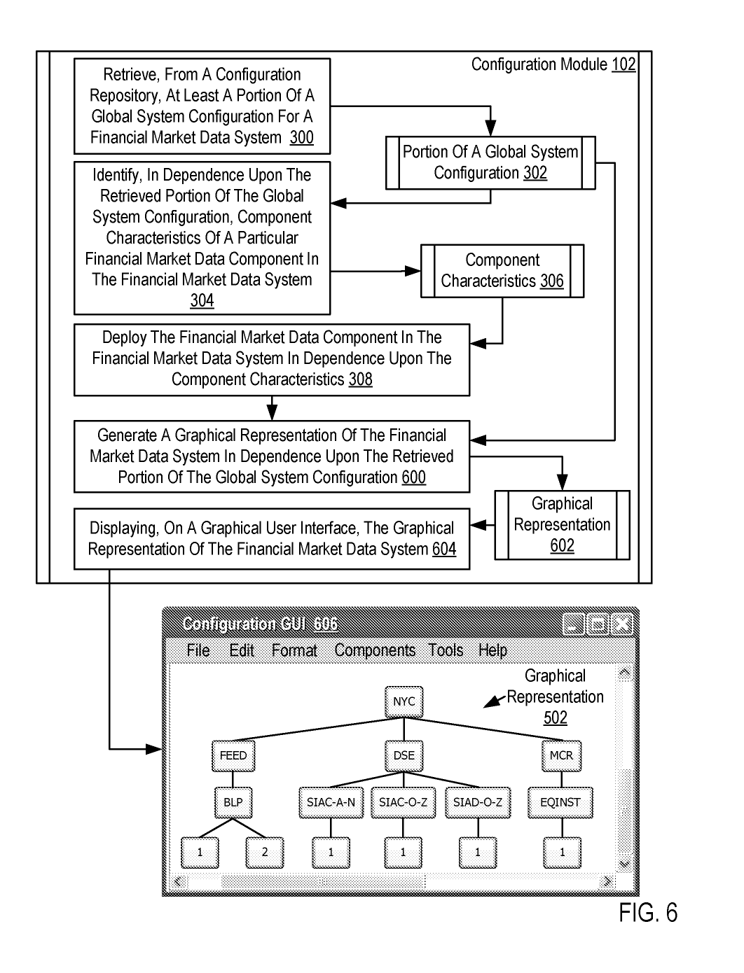

In addition to using a global system configuration to deploy a financial market data component in a financial market data system, a configuration module may also utilize the global system configuration to provide a system administrator with a graphical representation of the entire financial market data system. Because components are typically categorized and identified according to their function type and business roles within the financial market data system, such a graphical representation of the entire financial market data system may be useful in identifying, configuring, and administering the various functions and their relationships in a financial market data system. For further explanation, therefore, consider FIG. 6 that sets forth a flowchart illustrating an exemplary method for establishing a financial market data component in a financial market data system according to embodiments of the present invention. The financial market data system includes a plurality of financial market data components.

The method of FIG. 6 is similar to the method of FIG. 3. That is, the method of FIG. 6 includes: retrieving (300), by a configuration module (102) from a configuration repository (103), at least a portion (302) of a global system configuration (104) for a financial market data system; identifying (304), by the configuration module (102) in dependence upon the retrieved portion (302) of the global system configuration (104), component characteristics (306) of a particular financial market data component in the financial market data system; and deploying (308), by the configuration module (102), the financial market data component in the financial market data system in dependence upon the component characteristics (306). The component characteristics (306) of FIG. 6 specify a component configuration for the particular component and any interface configurations for any interfaces of the particular component with any other financial market data components in the financial market data system. The component characteristics (306) of FIG. 6 also specify a system identifier, a component functional group identifier, and a component business group identifier. The system identifier specifies a particular financial market data system within a business organization in which the particular component is comprised. The component functional group identifier specifies a type of function provided by the particular component within the financial market data system. The component business group identifier specifies a business role provided by the particular component within a set of the financial market data components having the same component functional group identifier.

The method of FIG. 6 also includes generating (600), by the configuration module (102), a graphical representation (602) of the financial market data system in dependence upon the retrieved portion (302) of the global system configuration. The graphical representation (602) of FIG. 6 represents the financial market data system as an acyclic graph. Each node of the graph represents a portion of financial market data component's fully specified identifier. Each edge of the graph connects two nodes. The graphical representation (602) of FIG. 6 may be implemented according to the Graph Description Language (‘GDL’), the eXtensible Graph Markup and Modeling Language (‘XGMML’), or in any other manner as will occur to those of skill in the art.

A fully specified identifier for a particular component is a concatenation of the component's system identifier, component function group identifier, component business group identifier, optionally the component business subgroup identifier, and optionally the component instance identifier. For example, consider the following exemplary fully specified identifier for a first instance of a feed adapter service providing SIAC™ market data from the CTS in a financial market data system in New York:
NYC.FEED.SIAC.CTS.1

In the exemplary fully specified identifier above, ‘NYC’ is the value for component's system identifier, which specifies that the component is comprised in the financial market data system in New York. ‘FEED’ is the value for the component's component function group identifier, which specifies that the component is a feed adapter service. ‘SIAC’ is the value for the component's component business group identifier, which specifies that the component provides SIAC™ market data. ‘CTS’ is the value for the component's component business subgroup identifier, which specifies that the component provides SIAC™ financial ticks from the CTS. ‘1’ is the value for the component's instance identifier, which specifies the first instance of the component.

The configuration module (102) may generate (600) a graphical representation (602) of the financial market data system in dependence upon the retrieved portion (302) of the global system configuration according to the method of FIG. 6 by parsing the retrieved portion (302) of the global system configuration to identify the fully specified identifier for each component in the financial market data system and creating nodes and edges in the graphical representation (602) according to the fully specified identifier for each component in the financial market data system. The configuration module (102) may create nodes and edges in the graphical representation (602) according to the fully specified identifier for each component in the financial market data system as follows: The configuration module (102) may create a node in the graphical representation (602) representing the system identifier. The configuration module (102) may then create, for each fully specified component identifier having the system identifier and a particular component function group identifier, a node in the graphical representation (602) representing the particular component function group identifier and an edge in the graphical representation (602) connecting the node representing the particular component function group identifier with the node representing the system identifier. The configuration module (102) may then create, for each fully specified component identifier having a particular component function group identifier and a particular component business group identifier, a node in the graphical representation (602) representing the particular component business group identifier and an edge in the graphical representation (602) connecting the node representing the particular component business group identifier with the node representing the component function group identifier. The configuration module (102) may then create, for each fully specified component identifier having a particular component business group identifier and a particular component business subgroup identifier, a node in the graphical representation (602) representing the particular component business subgroup identifier and an edge in the graphical representation (602) connecting the node representing the particular component business subgroup identifier with the node representing the component business group identifier. The configuration module (102) may then create, for each fully specified component identifier having a particular component business subgroup identifier and a particular component instance identifier, a node in the graphical representation (602) representing the particular instance identifier and an edge in the graphical representation (602) connecting the node representing the particular instance identifier with the node representing the component business subgroup identifier.

The method of FIG. 6 includes displaying (604), by the configuration module (102) on a graphical user interface (‘GUI’) (606), the graphical representation (602) of the financial market data system. The configuration module (102) may display (604) the graphical representation (602) of the financial market data system on a graphical user interface (606) according to the method of FIG. 6 by rendering the nodes specified in the graphical representation (602) on the graphical user interface (606) and rendering the edges specified in the graphical representation (602) that connect the nodes on the graphical user interface (606).

Exemplary embodiments of the present invention are described largely in the context of a fully functional computer system for establishing a financial market data component in a financial market data system. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernet™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of establishing a financial market data component in a financial market data system, the method comprising:
retrieving, by a configuration module from a configuration repository, at least a portion of a global system configuration for a financial market data system, the financial market data system comprising a plurality of financial market data components;
identifying, by the configuration module in dependence upon the retrieved portion of the global system configuration, component characteristics of a particular financial market data component in the financial market data system, the component characteristics specifying a component configuration for the particular component and any interface configurations for any interfaces of the particular component with any other financial market data components in the financial market data system, the component characteristics further comprise a system identifier, a component functional group identifier, and a component business group identifier, the system identifier specifying a particular financial market data system within a business organization in which the particular component is comprised, the component functional group identifier specifying a type of function provided by the particular component within the financial market data system, the component business group identifier specifying a business role provided by the particular component within a set of the financial market data components having the same component functional group identifier; and
deploying, by the configuration module, the financial market data component in the financial market data system in dependence upon the component characteristics.

2. The method of claim 1 wherein deploying, by the configuration module, the component in the financial market data system in dependence upon the component characteristics further comprises:
determining a component deployment configuration in dependence upon the component characteristics and a deployment ruleset; and
configuring one or more computing devices with the financial market data component in dependence upon the component deployment configuration.

3. The method of claim 1 further comprising:
generating, by the configuration module, a graphical representation of the financial market data system in dependence upon the retrieved portion of the global system configuration; and
displaying, by the configuration module on a graphical user interface, the graphical representation of the financial market data system.

4. The method of claim 1 wherein each financial market data component comprises one or more instances, the component characteristics for each instance further comprise a component instance identifier, each instance of each component belonging to a high availability tier and providing equivalent functionality within the financial market data system.

5. The method of claim 1 wherein the component characteristics further comprise a component business subgroup identifier, the component business subgroup identifier specifying an additional business role provided by a particular financial market data component within a set of financial market data components having the same component business group identifier.

6. The method of claim 1 wherein:
the component characteristics specify a business process interface through which the financial market data component exchanges business process messages with other financial market data components within the financial market data system;
the component characteristics specify a control interface through which the financial market data component exchanges control messages with other financial market data components within the financial market data system; and
the component characteristics specify an event interface through which the financial market data component exchanges state information with other financial market data components within the financial market data system.

7. The method of claim 1 wherein:
the component characteristics specify an external edge partition through which the financial market data component exchanges data with external components outside of the financial market data system; and
the component characteristics specify an infrastructure partition through which the financial market data component exchanges application messages with other financial market data components inside the financial market data system.

8. An apparatus for establishing a financial market data component in a financial market data system, the apparatus comprising a computer processor, a computer memory operatively coupled to the computer processor, the computer memory having disposed within it computer program instructions capable of:
retrieving, by a configuration module from a configuration repository, at least a portion of a global system configuration for a financial market data system, the financial market data system comprising a plurality of financial market data components;
identifying, by the configuration module in dependence upon the retrieved portion of the global system configuration, component characteristics of a particular financial market data component in the financial market data system, the component characteristics specifying a component configuration for the particular component and any interface configurations for any interfaces of the particular component with any other financial market data components in the financial market data system, the component characteristics further comprise a system identifier, a component functional group identifier, and a component business group identifier, the system identifier specifying a particular financial market data system within a business organization in which the particular component is comprised, the component functional group identifier specifying a type of function provided by the particular component within the financial market data system, the component business group identifier specifying a business role provided by the particular component within a set of the financial market data components having the same component functional group identifier; and
deploying, by the configuration module, the financial market data component in the financial market data system in dependence upon the component characteristics.

9. The apparatus of claim 8 wherein deploying, by the configuration module, the component in the financial market data system in dependence upon the component characteristics further comprises:
determining a component deployment configuration in dependence upon the component characteristics and a deployment ruleset; and
configuring one or more computing devices with the financial market data component in dependence upon the component deployment configuration.

10. The apparatus of claim 8 wherein the computer memory also has disposed within it computer program instructions capable of:
generating, by the configuration module, a graphical representation of the financial market data system in dependence upon the retrieved portion of the global system configuration; and
displaying, by the configuration module on a graphical user interface, the graphical representation of the financial market data system.

11. The apparatus of claim 8 wherein:
each financial market data component comprises one or more instances, the component characteristics for each instance further comprise a component instance identifier, each instance of each component belonging to a high availability tier and providing equivalent functionality within the financial market data system; and
the component characteristics further comprise a component business subgroup identifier, the component business subgroup identifier specifying an additional business role provided by a particular financial market data component within a set of financial market data components having the same component business group identifier.

12. The apparatus of claim 8 wherein:
the component characteristics specify a business process interface through which the financial market data component exchanges business process messages with other financial market data components within the financial market data system;
the component characteristics specify a control interface through which the financial market data component exchanges control messages with other financial market data components within the financial market data system; and
the component characteristics specify an event interface through which the financial market data component exchanges state information with other financial market data components within the financial market data system.

13. The apparatus of claim 8 wherein:
the component characteristics specify an external edge partition through which the financial market data component exchanges data with external components outside of the financial market data system; and
the component characteristics specify an infrastructure partition through which the financial market data component exchanges application messages with other financial market data components inside the financial market data system.

14. A computer program product for establishing a financial market data component in a financial market data system, the computer program product disposed upon a computer readable medium, the computer program product comprising computer program instructions capable of:
retrieving, by a configuration module from a configuration repository, at least a portion of a global system configuration for a financial market data system, the financial market data system comprising a plurality of financial market data components;
identifying, by the configuration module in dependence upon the retrieved portion of the global system configuration, component characteristics of a particular financial market data component in the financial market data system, the component characteristics specifying a component configuration for the particular component and any interface configurations for any interfaces of the particular component with any other financial market data components in the financial market data system, the component characteristics further comprise a system identifier, a component functional group identifier, and a component business group identifier, the system identifier specifying a particular financial market data system within a business organization in which the particular component is comprised, the component functional group identifier specifying a type of function provided by the particular component within the financial market data system, the component business group identifier specifying a business role provided by the particular component within a set of the financial market data components having the same component functional group identifier; and
deploying, by the configuration module, the financial market data component in the financial market data system in dependence upon the component characteristics.

15. The computer program product of claim 14 wherein deploying, by the configuration module, the component in the financial market data system in dependence upon the component characteristics further comprises:
determining a component deployment configuration in dependence upon the component characteristics and a deployment ruleset; and
configuring one or more computing devices with the financial market data component in dependence upon the component deployment configuration.

16. The computer program product of claim 14 further comprising computer program instructions capable of:
generating, by the configuration module, a graphical representation of the financial market data system in dependence upon the retrieved portion of the global system configuration; and
displaying, by the configuration module on a graphical user interface, the graphical representation of the financial market data system.

17. The computer program product of claim 14 wherein each financial market data component comprises one or more instances, the component characteristics for each instance further comprise a component instance identifier, each instance of each component belonging to a high availability tier and providing equivalent functionality within the financial market data system.

18. The computer program product of claim 14 wherein the component characteristics further comprise a component business subgroup identifier, the component business subgroup identifier specifying an additional business role provided by a particular financial market data component within a set of financial market data components having the same component business group identifier.

19. The computer program product of claim 14 wherein:
the component characteristics specify a business process interface through which the financial market data component exchanges business process messages with other financial market data components within the financial market data system;
the component characteristics specify a control interface through which the financial market data component exchanges control messages with other financial market data components within the financial market data system; and
the component characteristics specify an event interface through which the financial market data component exchanges state information with other financial market data components within the financial market data system.

20. The computer program product of claim 14 wherein:
the component characteristics specify an external edge partition through which the financial market data component exchanges data with external components outside of the financial market data system; and
the component characteristics specify an infrastructure partition through which the financial market data component exchanges application messages with other financial market data components inside the financial market data system.
